(19) United States
(12) Patent Application Publication
(10) Pub. No.: US 2006/0015871 A1
(43) Pub. Date: Jan. 19, 2006

(54) Storage system management software cooperation method

(76) Inventors: Hironori Emaru, Yokohama (JP); Masahide Sato, Noda (JP); Hirokazu Ikeda, Yamato (JP); Masahiro Yamada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/951,614

(22) Filed: Sep. 29, 2004

(30) Foreign Application Priority Data
Jul. 15, 2004 (JP) 2004-208501

(51) Int. Cl. G06F 9/46

(52) U.S. Cl. 718/100

(57) ABSTRACT

Information of plural management programs is integrated to predict influence caused by a change in configuration. There is provided a computer system including: a storage subsystem provided with plural disks and a disk array control unit; and a management computer provided with a control unit which manages the storage subsystem, wherein the control unit obtains upon receiving an execution request event which has taken place in a management program provided to manage the computer system, a management job that is associated with the event, and marks up an extent of the impact of the event along with the management job associated with the event.

### CLAIM OF PRIORITY

The present application claims priority from Japanese application P2004-208501 filed on Jul. 15, 2004, the content of which is hereby incorporated by reference into this application.

### BACKGROUND

This invention relates to a storage system management software cooperation method, and more particularly to a method of having plural management programs automatically execute management jobs, in particular, management jobs that involve a change in configuration.

There are various tasks that utilize an information processing device. For instance, in management of storage systems on SAN, a policy regulating what action (management job) is to be executed when what subject fulfils what condition is set to those disk drives. Then information on the busy or idle condition of the storage systems is collected and the value of the policy subject is obtained based on the collected information to judge whether or not the value of the subject satisfies the policy condition. When it is judged as a result that the policy condition is met, the policy action is executed. A technique has been proposed which automatically manages storage systems on SAN based on the thus predicted busy or idle condition of the storage systems and other factors (refer to JP2003-345632A).

### SUMMARY

In order to operate a system automatically by applying a combination of management programs designed for different purposes to such management jobs, there should be no contradiction between the management jobs. This is not always achieved since each management program only covers its own management scope and the management function of one management program may cause inconsistency in information possessed by another program, resulting in failure in correct management of a management target.

This invention has been made in view of the above, and it is therefore an object of this invention to prevent, when plural management programs which manage and refer the same configuration automatically execute management jobs that involve a change in configuration, simultaneous execution of the management jobs from creating a contradiction in configuration.

It is another object of this invention to stop, when, for example, a part of the configuration that is managed by one management program is changed by a management job of another management program making continuation of automatic execution of management programs impossible, execution of this management program, so that the system is prevented from continuing while there is a contradiction between management programs and the configuration in their management scopes.

An embodiment of this invention provides a computer system composed of a storage subsystem (system) that has plural disks and a disk array control units, and a management computer that has a control unit for managing the storage subsystem. The control unit holds the configuration of a management target as a management map, which ensures that it is no more than one management program that refers, or changes, one configuration at a time.

An embodiment of this invention is capable of avoiding creating a contradiction in configuration from simultaneous execution of management programs which consult the same configuration or are allowed to change the configuration.

Also, an embodiment of this invention is capable of stopping, when, for example, a part of the configuration that is managed by one management program is changed by a management job of another management program making continuation of automatic execution of management programs impossible, execution of this management program, so that the system is prevented from continuing while there is a contradiction between management programs and the configuration in their management scopes.

### BRIEF DESCRIPTION OF THE DRAWINGS

The present invention can be appreciated by the description which follows in conjunction with the following figures, wherein:

FIG. 1 is a block diagram of a computer system according to a first embodiment of this invention.

FIG. 2 is an explanatory diagram of the configuration of a storage subsystem which is a management target in the first embodiment of this invention.

FIG. 3 is an explanatory diagram of the configuration of a monitor control program according to the first embodiment of this invention.

FIG. 4A and FIG. 4B are explanatory diagrams of maps used by the monitor control program according to the first embodiment of this invention.

FIG. 5 is a flow chart showing processing of the monitor control program according to the first embodiment of this invention upon reception of an event.

FIG. 6 is a flow chart of a management program executing a management job according to the first embodiment of this invention.

FIG. 7A to FIG. 7D are explanatory diagrams of an event management table used by the monitor control program according to the first embodiment of this invention.

FIG. 8A and FIG. 8B are explanatory diagrams of an event management table used by a monitor control program according to a second embodiment of this invention.

FIG. 9A to FIG. 9C are explanatory diagrams of a map used by the monitor control program according to the second embodiment of this invention.

### DETAILED DESCRIPTION OF THE PREFERRED EMBODIMENTS

Embodiment of this invention will be described below with reference to the accompanying drawings.

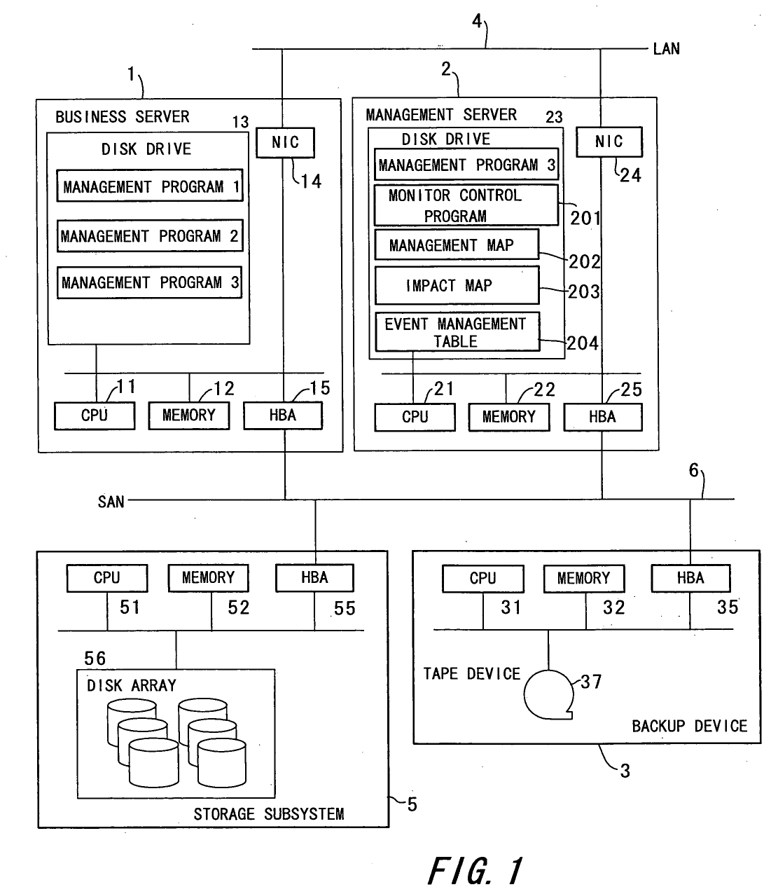

FIG. 1 is a block diagram showing the configuration of a computer system according to a first embodiment of this invention.

The computer system of this embodiment is composed of an business server 1, a management server 2, a backup device 3, a storage subsystem 5, and networks 4 and 6 which connect these components to one another.

The business server 1 is a computer device equipped with a CPU 11, a memory 12, a disk drive 13, a network interface (NIC) 14, a host bus adapter (HBA) 15, and an input/output device. Management programs 1 to 3 stored in the disk drive 13 are loaded to the memory 12 to be executed by the CPU 11 for management of the computer system.

The management programs include a capacity management program for managing the percentage of a disk used to dynamically allocate the disk to an application, a data protection program for backing up and restoring data used by an application, and a device management program for managing the operation of switches provided in the storage subsystem and in a SAN 6. How these management programs are executed differs from one to another; one may be executed by an administrator on demand and another may be executed automatically following a policy set by an administrator.

The management server 2 is a computer device equipped with a CPU 21, a memory 22, a disk drive 23, a network interface (NIC) 24, a host bus adapter (HBA) 25, and an input/output device. A management program stored in the disk drive 23 is loaded to the memory 22 to be executed by the CPU 21 for management of the computer system. In the management server 2, the CPU 21 extracts a management map 202, an impact map 203, and an event management table 204, which are stored in the disk drive 23, in the memory, and the CPU 21 executes a monitor control program, which similarly loaded to the memory, and then create contents of the impact map 203.

The business server 1 and the management server 2 may be placed in the same hardware or different hardware.

The backup device 3 is a computer device equipped with a CPU 31, a memory 32, a host bus adapter (HBA) 35, a tape device 37, and an input/output device. The backup device 3 functions as a tape backup server.

The CPU 31 of the backup device 3 executes a program, so that data stored in the storage subsystem 5 is backed up on a tape in response to a backup request from the management server 2.

The backup device 3 may have, instead of the tape device 37, a magnetooptical disk device or other similar device which backs up data in a backup medium.

The business server 1 and the management server 2 are connected via the LAN 4. The LAN 4 makes data and control information communicable between computers with the TCP/IP protocol or the like. For example, Ethernet, can be used as the LAN 4.

The storage subsystem 5 is composed of a disk array controller and a disk array 56. The disk array controller is constituted of a CPU 51, a memory 52, and a host bus adapter (HBA) 55. The CPU 51 executes a control program to control input and output of data in the disk array 56 in response to a request from the business server 1.

The disk array 56 is a Redundant Array of Independent Disks (RAID) and stores data with redundancy. Because of this redundancy, a loss of stored data is prevented when a failure takes place in some of disk drives that constitute the disk array 56.

The storage subsystem 5 is connected by the SAN 6 to the business server 1, the management server 2, and the backup device 3. The SAN 6 is a network capable of data communication with a protocol suitable for transfer of data, for example, the fiber channel protocol.

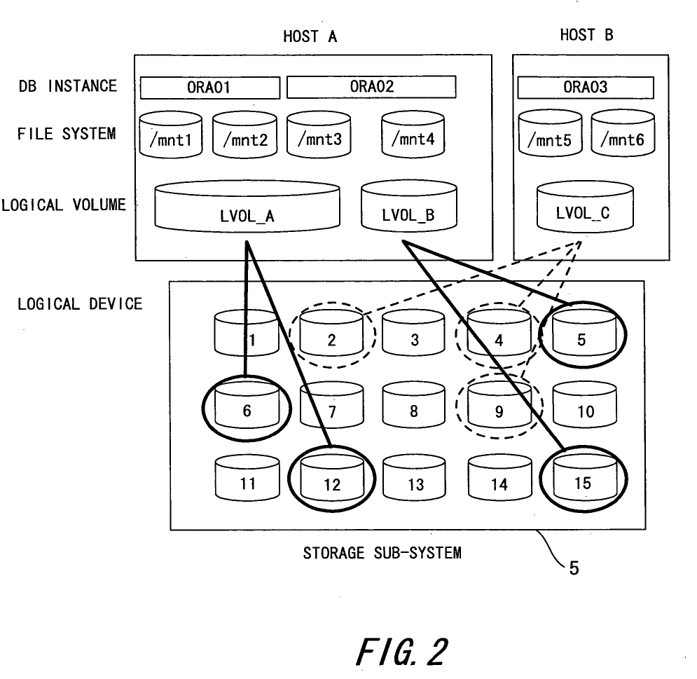

FIG. 2 is a block diagram showing the resource configuration of the computer system according to the first embodiment of this invention.

The storage subsystem 5 is connected via the SAN 6 to a host A and a host B, which access the disk drives of the storage subsystem 5.

The host A executes an application program (e.g. database program) and handles plural database instances. The database instances are each mounted with single file system or plural file systems. Each of the file systems is associated with one or more logical volumes. The logical volume is the unit of disks that can be recognized by a host. Each logical volume is composed of single logical device file or plural logical device files. Logical devices are each composed of single physical disk drive or plural physical disk drives.

The computer system where many servers share a single storage subsystem and the configuration of the storage subsystem is desired to be shielded from application programs, is managed in such hierarchies unlike usual PCs. It is an advantage of the hierarchical management that an operating system or an application program does not need to consider how data it uses is arranged. But it is a disadvantage of the management of plural layers which is unavoidable in managing storage.

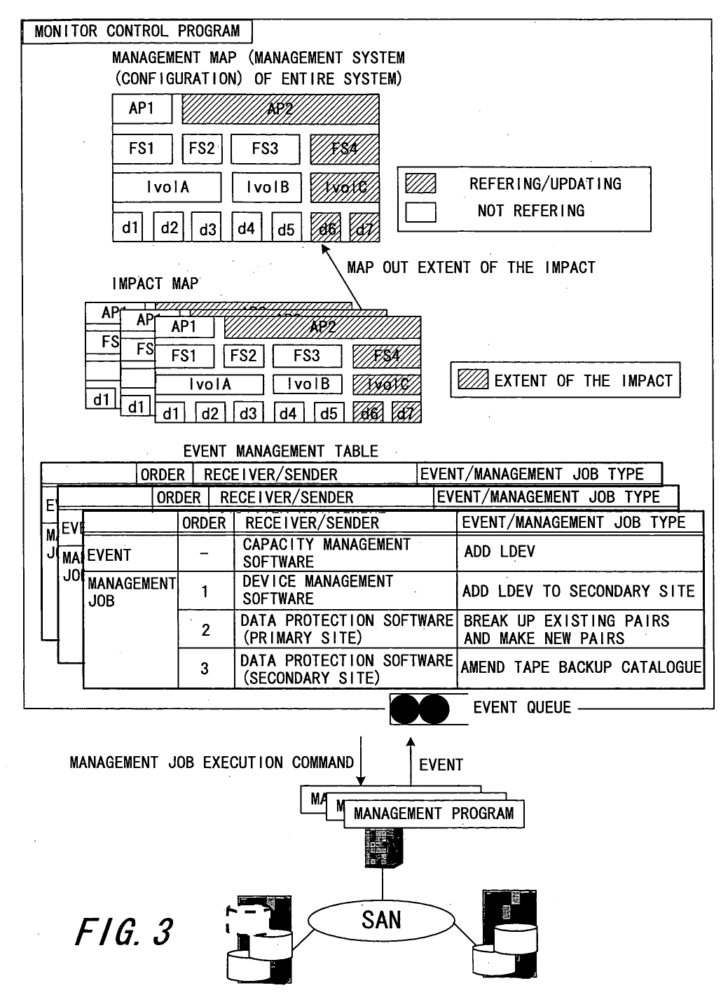

FIG. 3 is a conceptual diagram of the first embodiment of this invention.

In this invention, an event is issued to the monitor control program before a management program carries out a management job. There are three types of event issued from a management program to the monitor control program.

The first event of the three is an execution request event. The execution request event is issued when a management program is about to carry out a management job. No management program is allowed to execute its management job until it receives a management job execution command. Upon receiving the execution request event, the monitor control program carries out processing which will be described later (FIG. 5).

The second event is a configuration changing event. The configuration changing event is issued, upon a change in configuration, from a management program that is executing a management job. Basically, a management program that has received a management job execution command issues the configuration changing event whereas other management programs may issue the configuration changing event when a failure occurs or on other occasions. The monitor control program rewrites the management map and the impact map upon receiving the configuration changing event.

The third event is an execution completion event, which is issued from a management program that is executing a management job as a notification of completion of the management job.

No management program is allowed to execute its management job unless it receives a management job execution command from the monitor control program. A management job cannot be executed when an execution permission is not received.

Upon receiving an event, the monitor control program chooses an impact map from an event management table that corresponds to the received event, and marks up the extent of the impact onto the management map. Then the monitor control program sequentially sends management job execution commands to management programs based on the event management table.

Thus events defined in an event management table are sequentially transferred to designated management programs and the management programs inquire of the monitor control program upon executing processing for management jobs that involve referring or changing a configuration. Each management program checks whether other management programs are operating in its operation range before carrying out its operation. This way the system can be run automatically with fewer contradictions.

The monitor control program accumulated, in the management map extents of the impact marked up by the management programs.

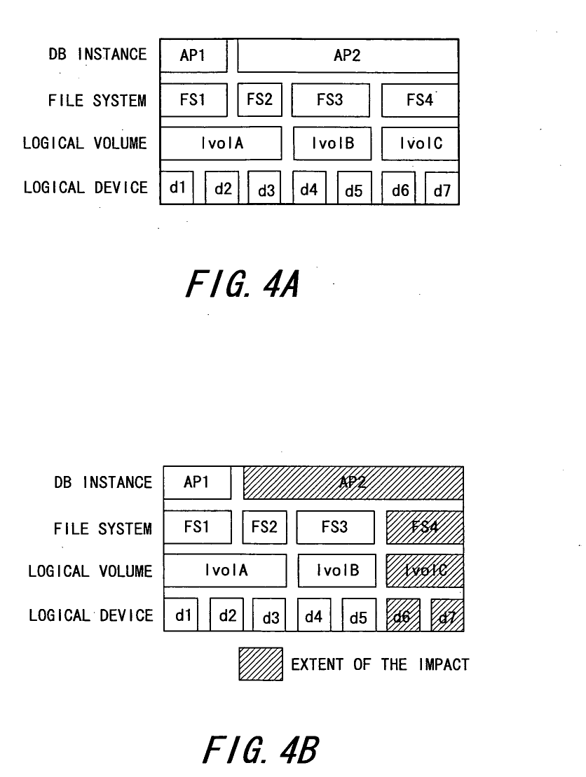

FIG. 4A and FIG. 4B are explanatory diagrams of the management map and impact map used in the first embodiment of this invention.

The management map shown in FIG. 4A has marked up therein resources (e.g. DB instances, file systems, logical volumes, and logical devices) of the hierarchy from the host down to the storage subsystem 5.

Resource information of each layer is obtained by using a command or the like. The obtained resource information of each layer is kept in a repository while maintaining the association between layers. The management map 202 is created from information accumulated in the repository. The repository is an area for storing resource information of each layer, and is placed in the disk drive 23 of the management server 2 or in the memory 22 of the management server 2.

The monitor control program is capable of mapping a map range of a specific impact map onto the management map and undoing the mapped range. The monitor control program also determines whether a received event is to be executed by referring to the mapping range on the management map.

The impact map (FIG. 4B) is the range of a resource influenced from an event which is mapped onto the management map. The impact map is created by keeping, as parameters, data of how high or low layers are influenced from management jobs of the respective management programs and mapping the parameters onto the management map. When one event takes place and an irrelevant operation is carried out in the range of the event, inconsistencies could be caused in both operations. The impact map makes it possible to know the extent of influence over the system configuration and accordingly avoid such inconsistencies.

FIG. 5 is a flow chart of the monitor control program according to the first embodiment of this invention which is executed by the CPU 21.

The CPU 21 which executes the monitor control program receives an event from a management program (Step S101) and performs processing that corresponds to the type of the event received.

When the received event is a configuration changing event, the CPU 21 makes the configuration change reflected on the management map and the impact map (Step S114) and waits for the arrival of the next event (Step When the received event is an execution request event, the CPU 21 consults the event management table to extract a management job associated with the received event, and determines how to cope with the event (Step S102).

Then the CPU 21 judges whether it is necessary to register the extracted management job that is associated with the event in the management map (Step S103). Whether the management job to be executed affects the resource configuration determines the judgment result. For instance, when the event is addition of a logical device, marking up in the management map is necessary whereas marking up in the management map is unnecessary when the event is to display on a screen of the management server.

When marking up in the management map is judged to be unnecessary, the procedure moves to Step S106. On the other hand, when marking up in the management map is judged to be necessary, the CPU 21 judges whether other management jobs whose extent of the impact overlaps the extent of the impact of the extracted management job are being executed (Step S104). When the other management jobs whose extent of the impact overlaps are being executed, the CPU 21 performs queuing so that the extracted management job that is associated with the event is stored in an execution event queue (Step S112).

The management job stored in the execution event queue is then executed provided that there is no change in configuration in the extent of the impact. When the configuration is to be changed in the extent of the impact, the CPU 21 notifies the management program of the configuration change. The event stored in the event queue is searched upon completion of the event processing that has been executed, and again subjected to the judging in Step S104. When there is a configuration change in the extent of the impact, the CPU 21 notifies the management program of the configuration change.

In the case where no management job whose extent of the impact overlaps the extent of the impact of the extracted management job is being executed, the CPU 21 sets the extent of the impact of the mapping table 202 to “referring/updating” and marks up the extent of the impact in the management mapping table 202 (Step S105).

The above processing completes an update of the management map 202, and now the CPU 21 is ready to send a management job execution command to the management program, thereby starting execution of the management job defined in the event management table (Step S106).

When the received event is an execution completion event, the CPU 21 judges whether a management job defined in the event management table is still left (Step S108). When it is found as a result that a management job that has not been executed yet is left in the event management table, the procedure returns to Step S106 where a management job execution command is issued to a management program to continue execution of management jobs.

On the other hand, in the case where every management job defined in the event management table has already been executed, the CPU 21 checks whether “referring/updating” is marked-up in the management map 202 (Step S109). When the “referring/updating” marking is found, the marking is removed from the management map 202 and marking of the extent of the impact is also removed from the management map 202 (Step S1 0).

The CPU 21 then checks whether the event queue is empty (Step S116). When the event queue is empty, the processing is ended without further operation. When the event queue is not empty, the CPU 21 checks whether a configuration changing event has taken place while the current event is being processed (Step S111). When it is found as a result that a configuration changing event has taken place, the management program notified of the event stored in the event queue is notified issuer of request of cancellation of the management job (Step S113), and the processing is ended. On the other hand, when it is found as a result that no configuration changing event has taken place during the period, the event is searched from the forefront event queue to be executed (Step S115). To retrieve events from the event queue, the event that is stored in the event queue earliest is retrieved first. Alternatively, events may have priority attributes so that the event that has the highest priority of the events stored in the event queue is retrieved first.

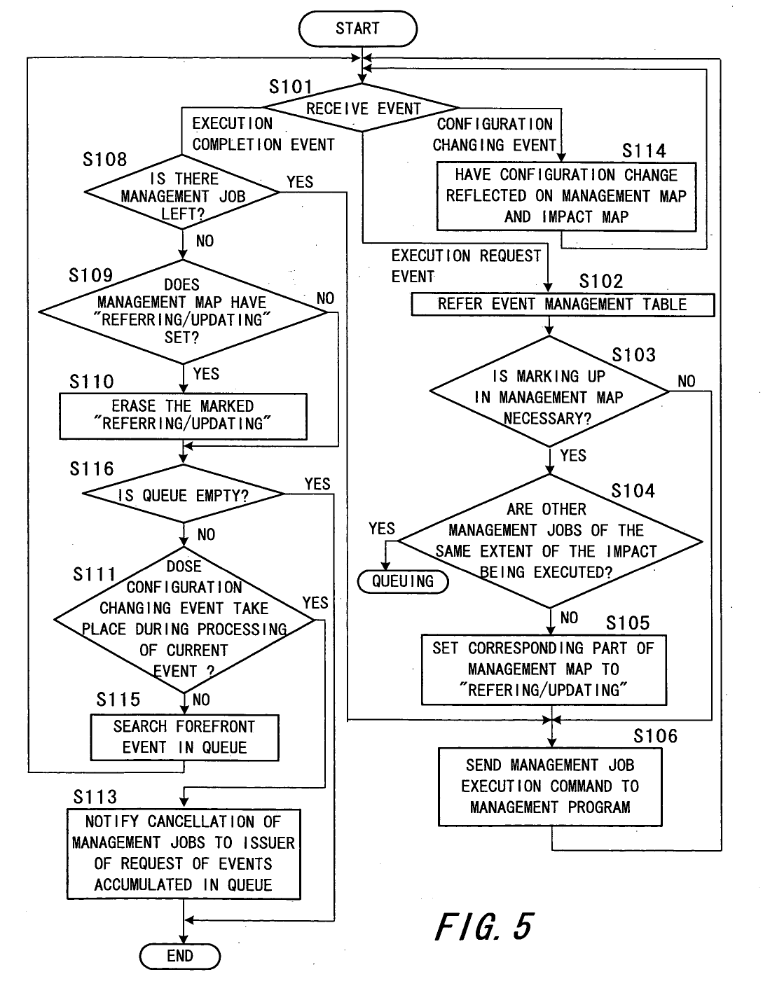

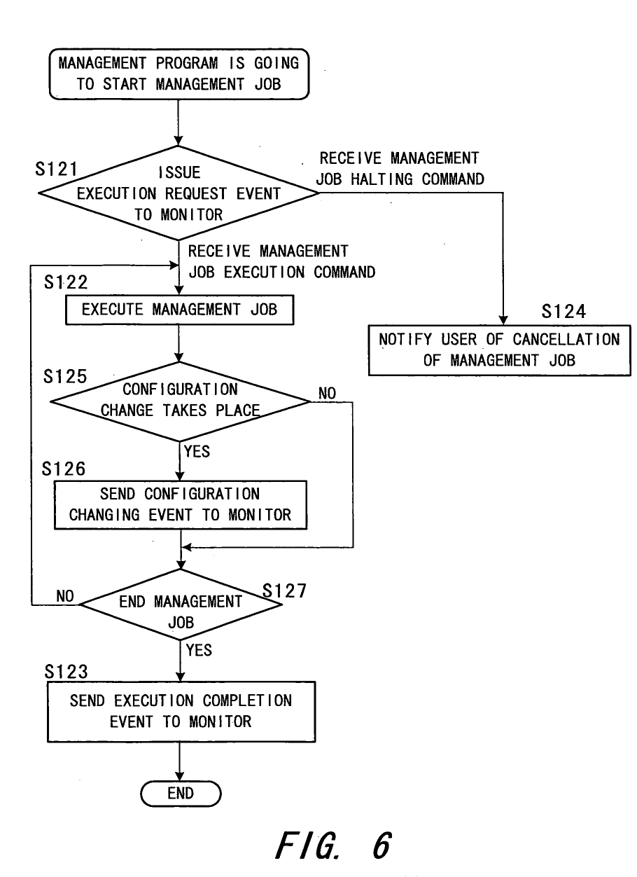

FIG. 6 is a flow chart of processing according to the management programs of the first embodiment of this invention. The processing is performed by the CPU 11 and CPU 21.

A management program issues an execution request event to a monitor control program 201 before starting its management job (Step S121). In response to the request event, the monitor control program sends either a management job execution command or a management job halting command, which is received by the management program.

When the management program receives the management job halting command, a user is notified of cancellation of the management job (Step S124).

On the other hand, reception of the management job execution command causes the management program to execute the management job (Step S122). Whether execution of the management job involves a configuration change is checked (Step S125).

When it is found as a result that a change in configuration takes place, the management program sends a configuration changing event to the monitor control program (Step S126). Subsequently, whether the management job is finished or not is judged (Step S127) and, when the management job is not completed yet, the procedure returns to Step S122.

When the management job is judged to be completed, the management program sends an execution completion event to the monitor control program (Step S123).

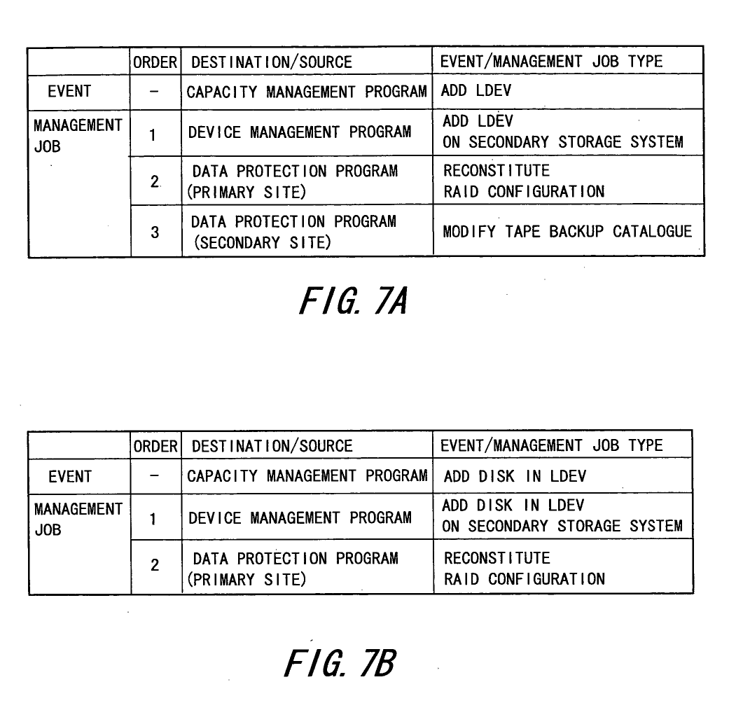

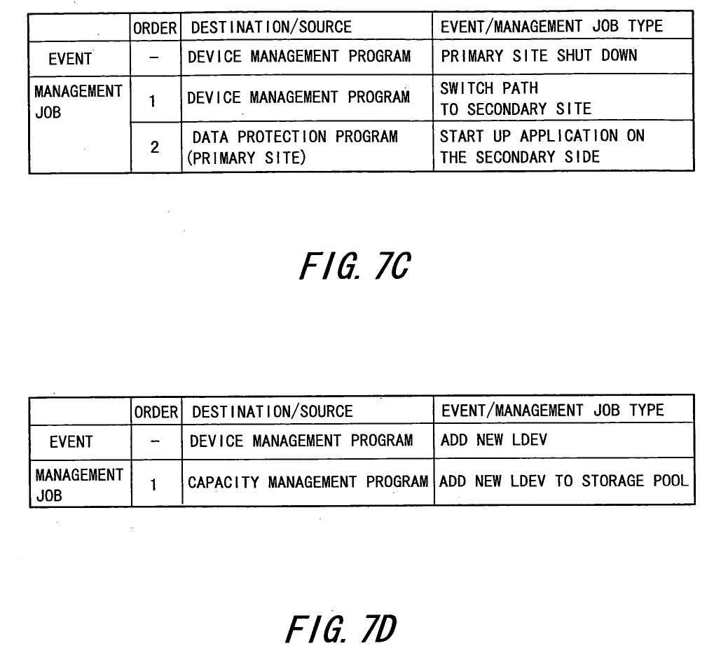

FIG. 7A to FIG. 7D are explanatory diagrams of the event management table according to the first embodiment of this invention.

The event management table states what event serves as an execution request event which starts execution, what program issues the event, what management job is to be executed upon occurrence of the event, and what program is to execute the management job. In other words, the event management table defines, for each of execution request events issued from the management programs, a management job executed by a management program as event and the procedure of carrying out the management job in context of operations of other management (software) programs.

FIG. 7A defines management jobs executed upon addition of a logical device (LDEV) to a primary storage subsystem in a pair configuration. As this event takes place, a device management program executes a management job 1 which adds a same specification's logical device to a secondary storage subsystem. After that, a data protection program on the primary site executes a management job 2 which reconstitute RAID configuration on the primary storage subsystem. After that a data protection program on the secondary site executes a management job 3 which modifies a tape backup catalogue. Accordingly, this event influences, along with the logical device added to the primary storage subsystem, a logical volume, file system, and DB instance that use the logical device added, logical devices which reconstitute the RAID configuration on the primary storage subsystem and logical devices on the secondary storage subsystem.

FIG. 7B defines management jobs executed upon addition of a disk drive in a logical device (LDEV) of a primary storage subsystem in a pair configuration. As this event takes place, a device management program executes a management job 1 which adds a same specification disk drive to a secondary logical device, and a data protection program on the primary site executes a management job 2 which reconstitute the RAID configuration on the primary storage subsystem. Accordingly, this event influences, along with the disk added to the primary storage subsystem, a logical device, logical volume, file system, and DB instance that use the disk added, logical devices which reconstitute the RAID configuration on the primary storage subsystem and logical devices on the secondary storage subsystem.

FIG. 7C defines management jobs executed for failover from a primary storage subsystem to a secondary storage subsystem when the primary site stops operating. In the failover, a device management program executes a management job 1 which switches paths so that a host is connected to the secondary site, and a data protection program on the secondary site executes a management job 2 which activate applications on the secondary site. Accordingly, this event influences a host (a path to the host) along with the primary storage subsystem and secondary storage subsystem.

While the above event management tables of FIG. 7A to FIG. 7C all define management jobs that need marking up in the management map upon occurrence of events, there are cases where an event management table defines only management jobs that do not need marking up in the management map upon occurrence of an event.

FIG. 7D defines management jobs executed upon addition of a logical device to the storage subsystem. In this case, the newly added logical device is placed in a storage pool and is not immediately put into use. Accordingly, a resource change that influences running of the storage subsystem does not takes place and marking up in the management map is unnecessary.

Another case, besides the case of FIG. 7D that does not need marking up in the management map where an added device is not immediately put into use is when a change is only displayed on the screen of the management server.

The description given above is about one event management table. In the case where a management job executed on one event management table serves as an event on another event management table, the event management table is traced more hierarchically to specify the range of influence of the event.

The first embodiment of this invention uses a configuration changing event to notify whether there is a configuration change in the respective management jobs. Alternatively, a configuration change may be notified when an execution completion event is sent to the monitor control program as incidental attributes of the event.

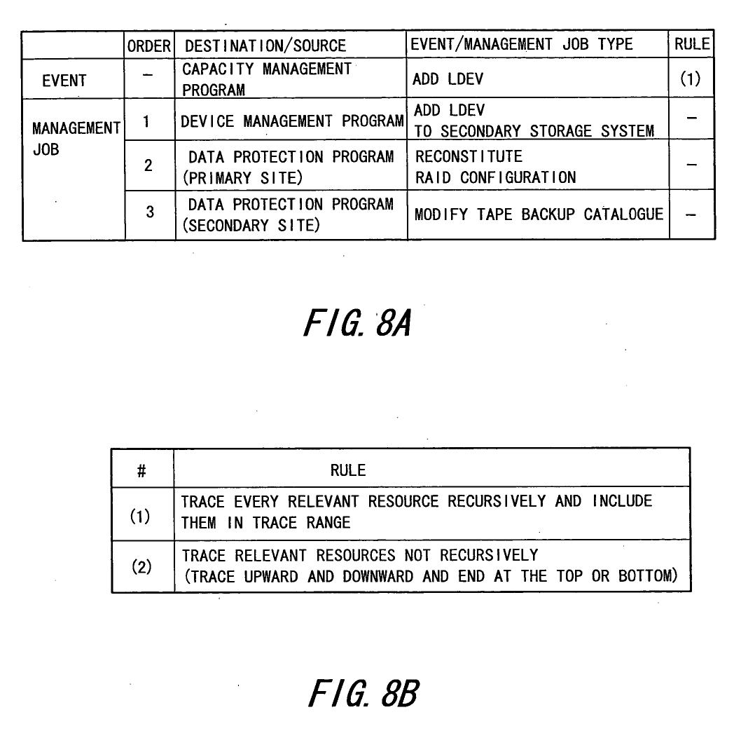

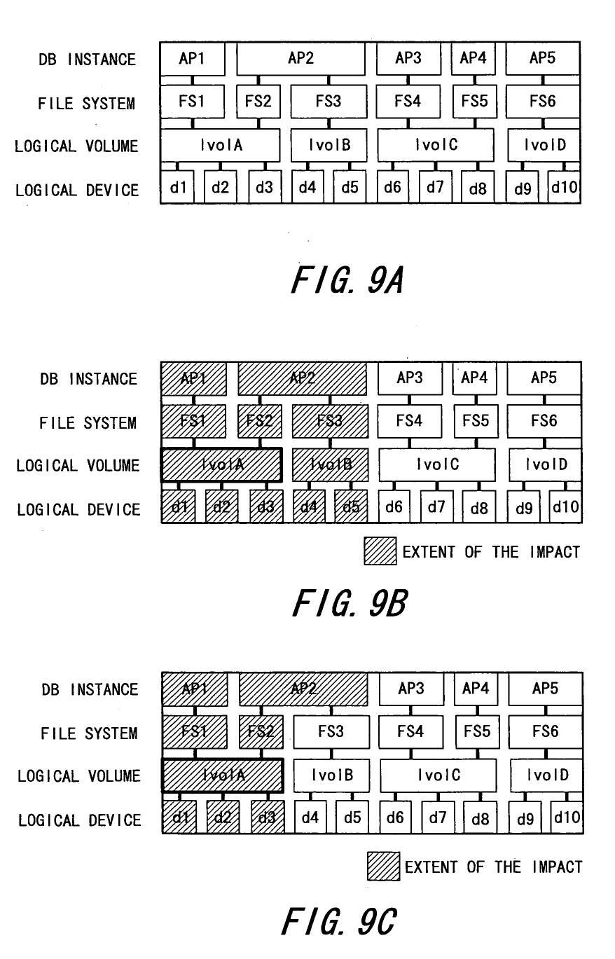

A second embodiment of this invention will be described next. An event management table in the second embodiment has a rule field (FIG. 8A and FIG. 8B) in addition to the fields contained in an event management table of the first embodiment. A management map 202 in the second embodiment has additional information about association between resources (FIG. 9A to FIG. 9C). Accordingly, the second embodiment does not use the impact map 203 of the first embodiment. Components in the second embodiment that are identical to those in the first embodiment are denoted by the same reference symbols and descriptions thereof will be omitted.

FIG. 8A and FIG.8B are explanatory diagrams of an event management table according to the second embodiment of this invention.

FIG. 8A shows the event management table. As mentioned above, this event management table has a rule definition in addition to items contained in an event management table of the first embodiment. The rule field shows a rule that is applied upon occurrence of an event. The other items is identical those in the first embodiment (FIG. 7A to FIG. 7D).

FIG. 8B shows a rule table. The rule table is consulted when an event takes place in its event source defined in the event management table, so that an extent of the impact is specified following the rule defined. For instance, a rule (1) provides to trace every resource relevant recursively and specify the result as a check range. In short, according to the rule (1), every resource that is relevant to the resource where the event in question takes place is included in the extent of the impact (FIG. 9B).

A rule (2), on the other hand, provides to trace relevant resources but not recursively. According to the rule (2), the resource where the event in question takes place is traced by tracing the hierarchy upward and the tracing is ended upon reaching the uppermost layer to specify the area covered as the extent of the impact. Alternatively, the hierarchy is traced downward and the tracing is ended upon reaching the lowermost layer to specify the area covered as the extent of the impact (FIG. 9C).

FIG. 9A to FIG. 9C are explanatory diagrams of the management map 202 according to the second embodiment of this invention.

The management map 202 of the second embodiment (FIG. 9A) holds hierarchized resources similar to the above-described management map of the first embodiment (FIG. 4A). Also marked up in the management map 202 of the second embodiment is the association between the resources in the respective layers. For instance, a logical volume A in the management map 202 is composed of logical devices d1, d2, and d3, and therefore the logical volume A is associated with the logical devices d1, d2, and d3.

FIG. 9B shows the management map 202 to which the rule (1) is applied when an event takes place in the logical volume A. The association is traced up and down the hierarchy from the logical volume A (lvolA) to find that the extent of the impact of the logical volume A includes the logical devices d1 to d3, file systems FS1 and FS2, and DB instances AP1 and AP2. Furthermore, resources in layers below the DB instance AP2, which is included in the extent of the impact, are traced to find that a file system FS3, a logical volume lvolB, and logical devices d4 and d5 are also included in the extent of the impact of the logical volume A.

FIG. 9C shows the management map 202 to which the rule (2) is applied when an event takes place in the logical volume A. The association is traced up and down the hierarchy from the logical volume A (lvolA) to find that the extent of the impact of the logical volume A includes the logical devices d1 to d3, the file systems FS1 and FS2, and the DB instances AP1 and AP2. Since, according to the rule (2), resources influenced by a resource that is influenced first hand are not included in the extent of the impact, specification of the extent of the impact is ended here.

According to this embodiment, the monitor control program applies the rule (1) when, for example, the execution request event in FIG. 8A is issued from lvola. Which rule is to be applied is determined uniquely by the type of the event, not by from where the event is issued. Therefore, the rule (1) is always applied to the event in FIG. 8A, namely, “add LDEV”.

As has been described, the second embodiment does not need to define a table for each resource where an event could take place since specification of the extent of the impact is made into rules based on the management map and the event type.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising:
a storage subsystem provided with plural disks and a disk array control unit; and
a management computer provided with a control unit which manages the storage subsystem,
wherein the management computer has a management map in which resources of the computer system are marked up, an event management table in which management jobs to cope with events that could take place in the computer system are marked up, and an event queue which stores events waiting to be executed, and
wherein the control unit:
obtains, upon receiving an execution request event which has taken place in a management program provided to manage the computer system, a management job that is associated with the event and determine how to cope with the event, referring to the event management table;
judges whether the obtained extent of the impact of the event needs to be marked up in the management map;
judges, when it is necessary to mark up the event in the management map, whether other events whose extent of the impact overlaps the extent of the impact of the event to be marked up are being executed;
stores the event in the event queue when the other events whose extent of the impact overlaps are being executed;
registers, when the other events whose extent of the impact overlaps are not being executed, the extent of the impact of the event along with the management job associated with the event, and then issuing a management job execution command to have the management job associated with the event executed; and
erases, upon completion of execution of the management job associated with the event, the extent of the impact marked up.

2. A computer system comprising:
a storage system provided with plural disks and a disk array control unit; and
a management computer provided with a control unit which manages the storage system,
wherein, upon receiving an execution request event which has taken place in a management program provided to manage the computer system, the control unit obtains a management job that is associated with the event and marks up an extent of the impact of the event along with the management job.

3. The computer system according to claim 2, further comprising event management information in which management jobs associated with events that could take place in the computer system are marked up,
wherein, upon receiving an execution request event which has taken place in a management program provided to manage the computer system, the control unit, referring to the event management information, obtains a management job that is associated with the event and determine how to cope with the event, and
wherein the control unit marks up an extent of the impact of the event along with the management job associated with the event.

4. The computer system according to claim 2, further comprising an event queue which stores events waiting to be executed, wherein
the control unit:
upon completion of execution of the management job associated with the event, erases the extent of the impact marked up, and
after the marking is erased, notifies an issuer of request of a management job that is stored in the event queue waiting to be executed of cancellation of the management job.

5. The computer system according to claim 2,
wherein a method of specifying an extent of the impact of the event is marked up in the event management information, and
wherein the control unit follows the extent of the impact specification method registered in the event management information to mark up the extent of the impact of the event along with a management job associated with the event.

6. A management computer comprising a control unit which manages a storage system provided with plural disks and a disk array control unit,
wherein, upon receiving an execution request event which has taken place in a management program provided to manage the storage system, the control unit obtains a management job that is associated with the event and marks up an extent of the impact of the event along with the management job.

7. The management device according to claim 6, further comprising event management information in which management jobs associated with events that could take place in the computer system are marked up,
wherein, upon receiving an execution request event which has taken place in a management program provided to manage the storage system, the control unit, referring to the event management information, obtains a management job that is associated with the event and determine how to cope with the event, and
wherein the control unit marks up an extent of the impact of the event along with the management job associated with the event.

8. The management device according to claim 6,
wherein the control unit comprises an event queue which stores events waiting to be executed, wherein
the control unit:
upon completion of execution of the management job associated with the event, erases the extent of the impact marked up, and
after the marking is erased, notifies an issuer of request of a management job that is stored in the event queue waiting to be executed of cancellation of the management job.

9. The management device according to claim 6,
wherein a method of specifying an extent of the impact of the event is marked up in the event management information, and
wherein the control unit follows the extent of the impact specification method registered in the event management information to mark up the extent of the impact of the event along with a management job associated with the event.

10. A computer program product for managing a computer system, the computer system comprising: a storage system provided with plural disks and a disk array control unit; and a management computer provided with a control unit which manages the storage system by a job net, the program controlling the computer system to:
obtain, upon receiving an execution request event which has taken place in a management program provided to manage the computer system, a management job that is associated with the event;
mark up an extent of the impact of the event along with the management job associated with the event.

11. The computer program product according to claim 10, the computer system further comprising event management information in which management jobs associated with events that could take place in the computer system are marked up, the program controlling the computer system to:
obtain, upon receiving an execution request event which has taken place in a management program provided to manage the computer system, a management job that is associated with the event and determine how to cope with the event, referring to the event management information; and
mark up the extent of the impact of the event along with the management job associated with the event.

12. The computer program product according to claim 10, the computer system further comprising an execution event queue which stores management jobs waiting to be executed, the program controlling the computer system to:
erase, upon completion of execution of the management job associated with the event, the extent of the impact marked up, and
notify, after the marking is erased, an issuer of request of a management job that is stored in the event queue waiting to be executed of cancellation of the management job.

13. The computer program product according to claim 10, the computer system further comprising a method of specifying an extent of the impact of the event registered in the event management information, the program controlling the computer system to follow the extent of the impact specification method registered in the event management information to mark up the extent of the impact of the event along with a management job associated with the event.
